(19) United States
(12) Patent Application Publication
(10) Pub. No.: US 2022/0074253 A1
(43) Pub. Date: Mar. 10, 2022

(54) LINEAR ACTUATOR

(71) Applicant: Nick Ede, Highland Heights, OH (US)

(72) Inventor: Nick Ede, Highland Heights, OH (US)

(21) Appl. No.: 17/471,516

(22) Filed: Sep. 10, 2021

Related U.S. Application Data
(60) Provisional application No. 63/076,454, filed on Sep. 10, 2020.

(51) Int. Cl. E05F 15/635; F16H 19/04; E05F 5/00

(52) U.S. Cl. CPC E05F 15/635; F16H 19/04; E05F 5/003; E05Y 2201/47; E05Y 2900/602; E05Y 2201/408; E05Y 2201/722

(57) ABSTRACT

An improved linear actuator designed as an opening and closing apparatus. The improved linear actuator includes an enclosure containing first and second cavities. A rail is designed to fit within the first cavity of the enclosure. A damper is mounted to the enclosure. First and second pegs support a tray secured to slots within the rail, and a tension spring within the second cavity of the enclosure and secured to a gear track of the rail to engage the rotary damping device whereby the first and second pegs control the movement of the tray.

### CROSS REFERENCE TO RELATED APPLICATIONS

This application claims the benefit of U.S. Provisional Patent Application No. 63/076,454 filed on Sep. 10, 2020, which is incorporated in its entirety by reference herein.

### TECHNICAL FIELD OF THE INVENTION

The present invention relates to an improved linear actuator, and more particularly to an improved linear actuator designed as an opening and closing apparatus

### BACKGROUND OF THE INVENTION

Conventionally, as such a lid opening and closing device, there is known a device in which a spring urges a lid from a closed position to an open position. Dampers have been widely applied to various covers which are capable of being opened and closed, generally providing a one-way damping effect for objects.

Heretofore, doors or lids, which will hereinafter simply be referred to as doors, of household electrical appliances, vehicle glove compartments, various kinds of furniture, and the like, have used a damper device in which a rack is provided upon the door and a pinion is provided upon the appliance so as to mesh with the rack. The pinion is provided with a damper utilizing the viscous property of oil in order to generate a resisting force against the pivotal motion of the door. The opening speed of the door is thus controlled so as to provide smooth opening thereof and to protect the door hinges as well as the door itself from the adverse effects of any shock forces.

### SUMMARY OF THE INVENTION

According to an embodiment of the present invention, there is disclosed an improved linear actuator designed as an opening and closing apparatus. The improved linear actuator includes an enclosure containing first and second cavities. A rail is designed to fit within the first cavity of the enclosure. A damper is mounted to the enclosure. First and second pegs support a tray secured to slots within the rail, and a tension spring within the second cavity of the enclosure and secured to a gear track of the rail to engage the rotary damping device whereby the first and second pegs control the movement of the tray.

According to a further embodiment of the present invention, there is disclosed an improved linear actuator designed as an opening and closing apparatus within a container. The improved linear actuator designed as an opening and closing apparatus within a container includes the improved linear actuator mountedly connected to an interior of the container. The improved linear actuator includes an enclosure containing first and second cavities, a rail having a lid attached thereto designed to fit within the first cavity of the enclosure, a damper mounted to the enclosure, first and second pegs to support a tray secured to slots within the rail, and a tension spring within the second cavity of the enclosure and secured to a gear track of the rail to engage the rotary damping device whereby the first and second pegs control the movement of the tray.

### BRIEF DESCRIPTION OF THE DRAWINGS

The structure, operation, and advantages of the present invention will become further apparent upon consideration of the following description taken in conjunction with the accompanying figures (Figs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three dimensional view of the improved linear actuator in an extended position within the enclosure, in accordance with the present invention.

FIG. 2 is a front, three dimensional sectional view of the improved linear actuator in an extended position within the enclosure, in accordance with the present invention.

FIG. 3 is a front, three dimensional view of the improved linear actuator in an extended position, in accordance with the present invention.

FIG. 4 is a front, three dimensional view of the improved linear actuator in a compressed position, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader and should not in any way be interpreted as limiting.

The improved linear actuator 10 relates to an opening and closing apparatus for use within a container 30 or the like. In particular, the improved linear actuator 10 is designed such that the container 30 can be opened and closed in an opening direction and a closing direction with an urging force of a single tension spring 12. Functionally, the improved linear actuator 10 is a device that mounts inside of the container 30 and acts as a lift/counterbalance to display a low weight item from within the enclosure, such as a shelf.

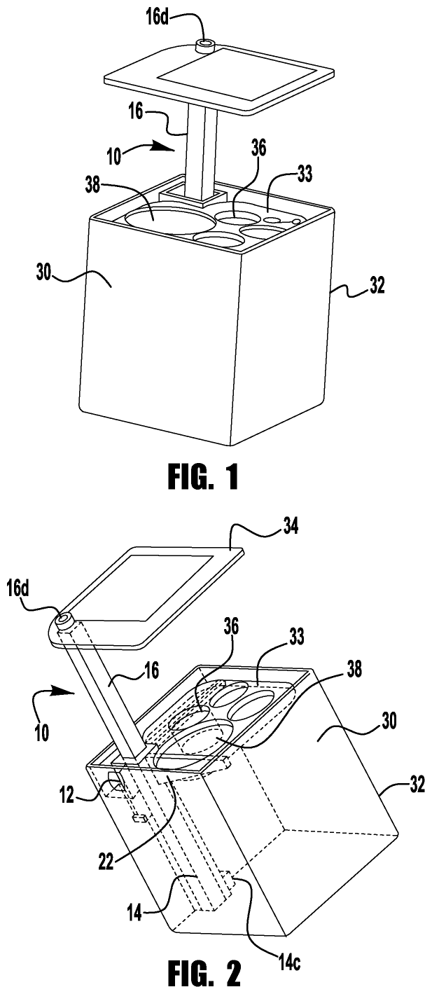

FIGS. 1 and 2 illustrate the container 30 which contains the improved linear actuator 10. The container 30 is generally constructed of a lightweight material, such as wood, plastic, or metal. Although illustrated as a rectangular cube, the container 30 may be formed of any suitable shape or dimensions. As illustrated in FIG. 2, the improved linear actuator 10 is mountedly connected to the interior of the container 30. The lid 34 of the container 30 is attached to the rail 16 of the linear actuator 10, and raises and lowers dependent on the orientation of the linear actuator 10. In the illustrated embodiment, the lid 34 attaches to the rail 16 with a fastener 16d.

The improved linear actuator 10 may be constructed of any desired materials, such as plastic pieces printed in PLA. Alternatively, other materials, such as nylon or metal may be utilized, or any combination thereof.

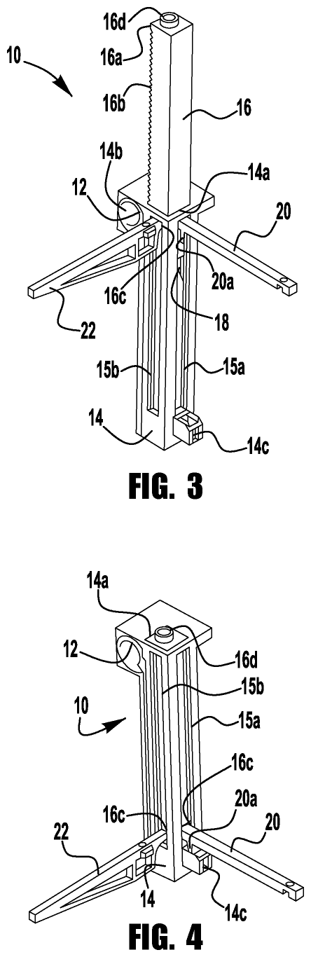

As illustrated in FIGS. 1 and 3, the elements of the improved linear actuator 10 include an enclosure 14, a rail 16, a damper 18, first and second pegs 20 and 22, and the tension spring 12 for power. The improved linear actuator 10 has first and second positions, extended and contracted, as seen in FIGS. 1 and 2, respectively.

When the improved linear actuator 10 is in its first contracted position, as shown in FIG. 4, it is fully contained within the container 30. Then, it can be activated and placed in its second extended position to raise the shelf from the confines of the container 30, as seen in FIGS. 1, 2 and 3. This allows for a more convenient and less obtrusive storage method.

As seen in FIG. 3, the enclosure 14 houses the various components of the improved linear actuator 10. The enclosure 14 contains first and second cavities 14a and 14b. The first cavity 14a is a vertical, elongated cavity extending the length of the enclosure 14, and designed to accommodate the rail 16. The second cavity 14b is a circular cavity disposed with an upper portion of the enclosure 14, and is designed to accommodate the tension spring 12. A mini push catch 14c is disposed on the bottom end of the enclosure 14 to secure the improved linear actuator 10 in a compressed state. This can be accomplished by interacting with an element 20s as discussed hereinafter.

As seen in FIG. 3, the rail 16 is an elongated rail designed to fit within the first cavity 14a of the enclosure. The rail 16 includes a slot 16a to mount to the tension spring 12. A gear track 16b can engage a damping device 18 mounted to the interior wall of the first cavity 14a. The damping device 18 can be constructed of a piece of material such as rubber or silicon which engages the gear track 16b to slow the movement of the gear track. Although the damping device 18 is shown, it is within the scope of the invention to provide the linear actuator 10 without the damping device. Slots 16c are provided in the wall of the gear track 16b to accommodate the ends of the first and second pegs 20 and 22. A top point 16d is provided at the top end of the gear track 16b to which can be mounted a lid 34.

The rail 16 can be alternatively extended from within the enclosure 14 to allow the improved linear actuator 10 to move into an extended state as shown in FIG. 3, and contained within the enclosure 14 to allow the improved linear actuator 10 to be in a compressed state as shown in FIG. 4.

FIG. 3 illustrate the first and second pegs 20 and 22. As noted earlier, the first and second pegs 20 and 22 are secured to the rail 16 and designed to support the platform or tray 33 that is elevated to the top of the container 30 when the improved linear actuator 10 is in an extended state. The tray 33 may be provided as a flat planar structure, or may include one or more hollowed portions, such as portion 36 and 38, to house any desired items. The first peg 20 includes a knob 20a that is releasably secured within the mini push catch 14c of the enclosure 14, as seen in FIG. 4, when the tray 33 is located in the bottom of the container 30.

As seen in FIGS. 3 and 4, the tension spring 12 is disposed within the enclosure 14. In a preferred embodiment, the tension spring 12 is a 1.75 lb spring, although it must be noted that the spring force can vary dependent on the desired application.

The spring 12 is attached at the bottom of the rail 16 through a slot it clips into and rides along in a groove in the side of the rail to reduce interference between the spring and the enclosure 14. At extended state, the rail 16 is pulled up by the constant force spring until pegs 20 and 22 reaches the top of the slots 15a and 15b formed in the wall of the enclosure 14 where the spring then acts as a counterbalance. The pegs 20 and 22 move along the length of the slots 15a and 15b.

FIG. 3 illustrates the damper 18, which is mounted to the enclosure 14. The damper 18 is a silicone based rotary damper custom to the weight of what is being lifted. The damper 18 can includes a gear that runs along the gear track 16b of the rail 16.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. An improved linear actuator designed as an opening and closing apparatus, comprising;
an enclosure containing first and second cavities;
a rail designed to fit within the first cavity of the enclosure;
first and second pegs to support a tray secured to slots within the rail; and
a tension spring within the second cavity of the enclosure and secured to a gear track of the rail to engage the rotary damping device whereby the first and second pegs control the movement of the tray.

2. The improved linear actuator of claim 1, wherein the improved linear actuator has a first extended position and a second contracted position.

3. The improved linear actuator of claim 2, wherein the improved linear actuator is in its first contracted position fully contained within a container, and in its second extended position raised from within the container.

4. The improved linear actuator of claim 1 wherein the first cavity is a vertical, elongated cavity extending the length of the enclosure, and designed to accommodate the rail.

5. The improved linear actuator of claim 5 wherein the second cavity is a circular cavity disposed with an upper portion of the enclosure to accommodate the tension spring.

6. The improved linear actuator of claim 6 wherein a mini push catch is disposed on a bottom end of the enclosure to secure the improved linear actuator in a compressed state.

7. The improved linear actuator of claim 1 wherein the rail includes a slot for the tension spring to secure to and a gear track to engage a rotary damping device.

8. The improved linear actuator of claim 8 wherein the rail further includes slots to accommodate the first and second pegs, and a top point for a lid to secure to.

9. The improved linear actuator of claim 8 wherein the first and second pegs support a tray that is elevated to a top of the container when the improved linear actuator is in an extended state.

10. The improved linear actuator of claim 9 wherein the first peg includes a knob that is temporarily secured within the mini push catch of the enclosure.

11. The improved linear actuator of claim 1 wherein the tension spring is attached at a bottom of the rail through a slot it clips into and rides along a groove in the rail to reduce interference of the spring with the enclosure and rail.

12. The improved linear actuator of claim 1 wherein a damper is mounted to the enclosure and includes a gear that runs along the gear track of the rail.

13. An improved linear actuator designed as an opening and closing apparatus within a container, comprising;
the improved linear actuator mountedly connected to an interior of the container, wherein the improved linear actuator includes;
an enclosure containing first and second cavities;
a rail having a lid attached thereto designed to fit within the first cavity of the enclosure;
first and second pegs to support a tray secured to slots within the rail; and
a tension spring within the second cavity of the enclosure and secured to a gear track of the rail to engage the rotary damping device whereby the first and second pegs control the movement of the tray.

14. The improved linear actuator of claim 13, wherein the improved linear actuator has a first extended position raised from within the container, and a second contracted position fully contained within a container.

15. The improved linear actuator of claim 13 wherein the first cavity is a vertical, elongated cavity extending the length of the enclosure, and designed to accommodate the rail, and the second cavity is a circular cavity disposed with an upper portion of the enclosure to accommodate the tension spring.

16. The improved linear actuator of claim 6 wherein a mini push catch is disposed on a bottom end of the enclosure to secure the improved linear actuator in a compressed state.

17. The improved linear actuator of claim 13 wherein the rail includes a slot for the tension spring to secure to and a gear track to engage a rotary damping device, and further includes slots to accommodate the first and second pegs, and a top point for a lid to secure to.

18. The improved linear actuator of claim 16 wherein the first peg includes a knob that is temporarily secured within the mini push catch of the enclosure.

19. The improved linear actuator of claim 13 wherein the tension spring is attached at a bottom of the rail through a slot it clips into and rides along a groove in the rail to reduce interference of the spring with the enclosure and rail.

20. The improved linear actuator of claim 13 wherein a damper is mounted to the enclosure and includes a gear that runs along the gear track of the rail.
